(19) United States
(12) Patent Application Publication
(10) Pub. No.: US 2005/0140119 A1
(43) Pub. Date: Jun. 30, 2005

(54) Shopping aid

(76) Inventor: Anthony H-Y Wong, Vancouver (CA)

Correspondence Address: Attn: K Karel Lambert;Intellisource Intellectual Property Services, PO Box 77417, Seattle, WA, 98177-0417, US

(21) Appl. No.: 10/771,672

(22) Filed: Feb. 3, 2004

Related U.S. Application Data
(60) Provisional application No. 60/533,564, filed on Dec. 31, 2003.

(51) Int. Cl. B62B 1/00

(52) U.S. Cl. 280/651

(57) ABSTRACT

The mechanical combination described here is a hybrid interconvertible shopping basket and wheeled vehicle. These combination shopping basket/vehicles are carried by a handle or strap, but may be interconverted at the customer's signal to wheeled baskets while continuing to shop. On wheels, these hybrids are generally freestanding, level, elevated to a convenient height, and can be rolled from place to place. These hybrids are specially adapted for a unique method of shopping, which also forms the basis for their sale and use in business as a specially adapted tool for merchandising.

### CROSS REFERENCE TO RELATED APPLICATIONS

The present application claims the benefit of priority to U.S. Provisional Patent Application Ser. No. 06/0533564 filed 31 Dec. 2003 (31-12-2003), as U.S. patent application Ser. No. 10/0771672, filed 3 Feb. 2004 (03-02-2004).

### TECHNICAL FIELD

Hand-propelled vehicles for transporting goods are the subject principally of US Class 280. The combination described here is a hybrid inter-convertible shopping basket and wheeled shopping vehicle. This hybrid is specially adapted for a unique method of shopping, which also forms the basis for its sale and use in business as a specially adapted tool for merchandising.

### BACKGROUND TO THE PROBLEM

Shopping carts at the market are a convenience for consumers, but the heavy carts must be pushed and are often hard to turn, slow-moving and inconvenient when the customer has only a few purchases to make. For this reason, many merchants also supply relatively small, lightweight shopping baskets, which typically have a basket handle or strap and are hand-carried by the shopping public.

Hurried customers who choose a shopping basket out of urgency are discouraged from purchasing more than is easily carried in the basket. Many times such shoppers find themselves in a dilemma, with no room left in the basket but more shopping to do. These customers have been clearly reluctant to return to the front of the store, exchange the basket for one of the larger carts—and then continue shopping. Often they will abandon the effort. This problem results in a measurable loss in sales to the merchant.

Shoppers generally rely on the merchant to supply the carts and baskets for shopping. Many convenience stores supply only shopping baskets, in part, because the aisles are often narrow and space is limited. In contrast, some large discounters do not supply shopping baskets at all because large shopping carts encourage shoppers to load up the cart with more items than could possibly be carried in a shopping basket. That is why so many merchants have paid to provide expensive shopping carts, although shopping baskets might be more than a hundred-fold cheaper.

The range of markets offering shopping baskets includes grocers, bakers, butchers, delicatessens, auto parts, hardware, art supply, builder's supply, marine supply, gift shops, sewing shops, minute markets, bait shops, pet shops, toy, electronic, and computer retailers, etc.; in general most brick-and-mortar retailers and some wholesalers worldwide. Experience has shown time and again that customers will buy more if they can readily carry the items.

However, shopping baskets rapidly fill up and become uncomfortably heavy, particularly with weighty items such as milk bottles, quarts of motor oil, melons, boxes of nails and the like. Customers who buy bulky and oversized items like cereal boxes, bath towels, pizza, flowers, action toys, baguettes, or paper diapers find that the basket handles are hard to carry when these items fill up the basket. Many baskets are not that strong, and trying to carry a watermelon in a shopping basket could be difficult. Customers will also find that the load in a basket can shift suddenly, causing items to fall from the basket and break.

Furthermore, customers waiting in lines at checkout may experience fatigue, muscle soreness, and hand pain due to the weight of the basket and purchases. In que, these customers sometimes put down the basket on a dirty floor and kick it along with their feet as the line advances.

Prior efforts to solve one or another facet of these problems from the perspective of the shopper have sought to offer customized shopping carts, some with convenience features designed to carry purchases from store-to-home without boxing at the checkstand. Others are designed to support shopping paper bags or plastic sacks and roll along a couple inches off the floor. Some of these carts can even fit in a pocket, but all must be purchased and maintained by the shopper. Various improvements have resulted in smaller, more maneuverable shopping carts, carts with multiple shelves, mesh baskets, carts that nest in various ways, and shopping baskets that fold up for storage, or are disassemblable and towed on wheels like a child's wagon (U.S. Pat. No. 5,906,383 to Cortes). One recent commercial introduction is a wheeled cart chassis with detachable basket, so that shoppers entering the store can select either the basket alone or the cart-with-basket. These products, however, fail to supply flexibility at the critical moment, when the hurried shoppers who have selected a shopping basket suddenly and offtimes ruefully realize that the basket is no longer adequate for their shopping needs (U.S. Pat. No. 5,865,449 to Castaneda).

Therefore, in practice, the existing shopping hardware solutions result in an inherent level of missed sales. While it might at first seem that the consumer would pay for a solution that offered shopping convenience and flexibility, in fact it is more likely the merchant who has the true incentive. The market has shown that it is the merchant, not the consumer, who typically provides the shopping hardware. By redefining the problem in this way, it becomes apparent that improved shopping hardware is needed to recover lost sales, a solution that requires the shopping basket to be redesigned so that heavy and bulky loads can be transported, even when they cannot be carried in the basket.

### SUMMARY

While shopping baskets offer a convenience for the hurried shopper, their use often results in lost sales for the merchant who supplies shopping baskets to customers. The solution disclosed here is a lightweight shopping basket (a custom that the shopping public is already familiar with) but one with an innovative combination, having a mechanism whereby pulling on a lever, leg, pressing a button, or some other means, triggers legs and wheels to deploy from the basket. In this solution, the hybrid shopping basket/vehicle-on-wheels then supports itself and can be rolled at a generally convenient height. Thus the solution offers both the convenience of a carryable basket and the option of a wheeled “shopping vehicle” when the need arises, ensuring that shoppers are not discouraged from buying more than they can readily carry. The hardware disclosed here is specially adapted to the needs of merchants as a sales tool, and is also useful to shoppers for its flexible shopping convenience.

A mechanical combination is disclosed having four basic elements: a lightweight shopping basket for carrying, legs and wheels, a mechanism for releasably securing the legs under the basket when not in use, and a triggering mechanism or means for releasing and deploying the legs so that the vehicle can be wheeled at a convenient height instead of carried, when desired. These hybrid shopping basket/vehicles are carried by a handle or strap, but may be interconverted at the customer's signal to a wheeled basket vehicle while shopping. The mechanism whereby the legs are deployed is preferably automatic once the signal is given but may be manual. On wheels, these baskets are generally freestanding, level, elevated to a convenient height, and can be rolled from place to place. These hybrid shopping basket/vehicles, termed here “shopping aids”, are specially adapted for a unique method of selling merchandise and for a unique method of shopping wherein the two aspects of the combination are used interconvertibly: with wheeled legs deployed when the basket is rolled; with wheeled legs undeployed when the basket is carried. Market owners who supply hardware to assist their customers in shopping are the preferred customers for hybrid shopping basket/vehicles, but the devices may also be sold directly to shoppers for personal use.

Multiple embodiments of these “hybrid shopping basket/vehicles” or combination devices are described, along with their uses in business methods for recovering lost sales. Shoppers who choose a hybrid shopping basket/vehicle instead of a basket are not forced to abandon their shopping when the basket gets too full or too heavy.

In one embodiment of the present invention the merchant provides the hurried customer with a lightweight hybrid shopping basket/vehicle that can be hand-carried in the store, but if the basket load becomes too heavy or cumbersome, then wheeled carriage legs are “deployed”, ie. extended to a standing, erect posture supporting the basket and locked in place, thereby allowing the customer to wheel, trundle or roll the basket along the floor at a convenient height while continuing to shop. The carriage legs are compactly secured under the basket when not in use. The legs are automatically deployed in response to a signal from the customer, generally by the touch of a control mechanism.

To more distinctly and clearly describe the invention, shopping baskets are differentiated from shopping carts, shopping trolleys and shopping wagons or prows. “Shopping basket” shall refer to any lightweight basket intended to be hand-carried for shopping, typically equipped with one or two basket handles or a strap. Typical weights of shopping baskets are less than 12 pounds (5.44 kg) at most. Shopping baskets as a class are often relatively small. “Shopping cart” shall refer to such devices having receptacles (commonly also called baskets) as are intended to be pushed along on a supporting chassis which bears the usually considerable weight of the larger receptacle or basket, often greater than 20 pounds (9.07 kg). In some designs, the basket of a shopping cart may be detachable from the wheeled chassis, such as for cleaning (as in U.S. Pat. No. 5,791,666), but the wheeled chassis is not intended to be carried along under the basket by a shopper. Rather the reverse, the basket is supported upon the chassis when the two are combined in the form of a shopping cart with the express intent of relieving the shopper of carrying anything. The nature of the handles also differ. Handles of shopping carts are adapted for pushing; shopping basket handles or straps are adapted for carrying. This can be readily observed by comparing U.S. Pat. No. 3,999,774 to Rehrig and U.S. Pat. No. 4,953,878 to Sbragia. In the latter, one device employs both manner of handles.

Shopping carts are simply too heavy to be conveniently carried, typically weighing more than 25 pounds (11.34 kg), with some metal carts having a basket/chassis combination weighing more than 75 pounds (34.02 kg); in contrast, shopping baskets are lightweight, typically weighing less than 12 pounds (5.44 kg), more preferably less than 6 pounds (2.72 kg), and most preferably less than 3 pounds (1.36 kg), well suited for being carried.

One class of wheeled shopping vehicles, termed here “shopping wagons”, consists of a platform or frame mounted on one or two axles and often a handle. These wagons generally are pulled relatively low to the floor and support a bag, sac, mesh container, fence, box or other disassemblable or foldable receptacle for carrying things. The receptacle can be of a disposable material, as of a plastic bag fitted over a supporting frame in the manner of a trash bag. Paper bags are also sometimes suggested as receptacles to be mounted on a wagon. These wagons are sometimes foldable, allowing a shopper to bring one to a market in a pocket or under an arm, and to then unfold the wagon in the market before shopping. In these configurations, the devices are suitable for shopping only if unfolded. Another variant offers some means of transferring the wagon or a detachable basket to and from an automobile (see for example U.S. Pat. No. 5,649,718 to Groglio). These designs as a class have had limited commercial success despite many, many years of improvement. The cumulative art is voluminous: U.S. Pat. Nos. 1,081,221; 2,531,856; 2,812,188; 3,190,673; 3,197,225; 4,185,848; 4,492,388; 4,596,387; 4,953,878; 5,865,449; 5,906,383, and 6,328,329 are representative. These wagons or carts are intended to be owned by the shopper, as taught for example explicitly by de Wit (U.S. Pat. No. 4,492,388).

Shopping carts and wagons, in addition, are of times designed for travel over exterior surfaces, such as asphalt or sidewalks and are weatherproof or rugged. However, the lightweight shopping baskets supplied by the merchant are generally used only in the store, not out in the parking lot, and are made available in nested stacks around the checkout stands and on the sales floor, where they quickly recirculate. These distinctions in structure and manner of use are useful in understanding the hybrid shopping basket/vehicles of the present disclosure.

It should be obvious that “wheel” as used herein refers to single axle wheels, rollers, tires, yoked wheels, and to casters, casters having rotational degrees of freedom around two generally perpendicular axles or axes, and that the inclusive term “wheel” is not limited by the material or mode of construction (being solid, composite or hollow), the tread width, diameter, or the nature and configuration of the axle(s) or bearings, if any. “Wheel” is synonymous with “wheel assembly”.

Other definitions as may be required to describe the invention are provided in the detailed description below.

Another embodiment of the present invention is a lightweight hybrid shopping basket/vehicle fitted with carriage legs and wheels, but one that can be easily hand-carried when the legs and wheels are unobtrusively secured in a folded or retracted configuration.

Another embodiment of the present invention is a hybrid shopping basket/vehicle combining some features of a shopping cart, such as generally stable, level, and elevated from the floor to a height where the basket is within reach of the shopper without un-due strain on the back or arms, but at a height above the typical shopping wagon and without the weight of a typical shopping cart. This height is measured at the base of the basket or receptacle, not the lip.

Another embodiment provides a handle or handles for a hybrid shopping basket/vehicle which are specially adapted for both pushing (or pulling) the hybrid shopping basket/vehicle like a cart and for carrying the hybrid shopping basket/vehicle like a basket. Alternatively, two functionally distinct handles may be supplied, one of which may be a strap.

Another optional embodiment provides a means for detachably attaching an “off-the-shelf”, commercially-available shopping basket, of which there are many brands, to a proportionate undercarriage having retractable deployable wheeled carriage legs, thus providing a device and kit for conversion of a shopping basket to a shopping vehicle. The undercarriage subassembly may be sold separately or with a shopping basket, and may be sold as a kit for self-assembly. When sold together as a kit, the undercarriage optionally may be an integral molded element of the base of the basket.

In certain embodiments, the hybrid shopping basket/vehicle is compact and nests within a vertical stack of like, empty hybrid shopping basket/vehicles, thus requiring less floor space for storage when not in use. In these embodiments, the small footprint of these stacks makes their placement in valuable merchandising space acceptable to the merchant.

In common embodiments, these and other needs are met by supplying the customer with a combination, or hybrid, shopping basket and vehicular elements including legs and wheels, with optionally an under-carriage, frame or running gear attached to or substantially part of the base of the shopping basket. The shopper carries what appears to be an ordinary shopping basket, but the basket is modified with triggerably releasable and deployable wheeled carriage legs, wheeled legs that can be conveniently brought down, stood up or “deployed” on demand, even when the basket is full, most preferably automatically. At the shopper's touch, for example, the legs are deployed and locked, and the freestanding, level, stably supported basket can then be rolled or wheeled from place to place or in any direction so that the shopper is relieved of carrying it and any contents. The undercarriage may be diminutive, forming part of the base of the basket, where it serves only as a point or points of attachment for the carriage legs.

Optionally, a hybrid shopping basket/vehicle has a shelf or shelves below the primary basket, thus lowering the center of gravity and providing additional room for purchases, and casters may be attached inferiorly to the bottom shelf plate instead of to the legs directly. These embodiments are also hybrid shopping basket/vehicles.

Optionally, a body member is used to automatically or semi-automatically deploy the legs. The shopper triggers release of the legs most commonly while carrying the basket by a handle or strap. In preferred embodiments, the legs can be deployed with a single hand while carrying the basket with the other. The use of a knee, thumb or index finger are other options. In some embodiments, the shopper must not only release the legs, but also deploy them manually.

Mechanical assists in the form of extensible handles, springs, a suspension, or one or more brakes may be provided. The legs, to avoid unexpected collapse of the basket, generally lock in place when deployed, for example with a spring-loaded detent pin, or may be designed to deploy at a positive camber and chocked.

From these and other embodiments of hybrid shopping basket/vehicles, the paradigm of shopping as customarily experienced is acquires a new dimension: that is, not only is new hardware for shopping introduced, but also a new method of shopping is made possible. Some shoppers who picked up a basket to carry into the store out of convenience or expediency need no longer regret the decision, and may instead choose to roll their hybrid shopping basket/vehicle to the checkstand. Other shoppers, given the convenience of the hybrid shopping basket/vehicle, will choose to continue shopping even after the basket is too full to readily carry by hand. The hybrid shopping basket/vehicle is specially adapted for this unique method of shopping, and linked method of business, yet offers no impediment to those who wish to continue to use the device as a shopping basket without making use of the wheels and legs. Methods of business in which a composition of the invention is employed in combination with a spreadsheet for controlling inventory, sales performance, or customer lists, include sales, leasing, repair, cleaning, assembly, retail and wholesale business models.

These and other embodiments of hybrid shopping basket/vehicles are expected to increase business by directly increasing sales volume and indirectly by reducing loss and labor due to spills or breakage, thus increasing unit employee productivity in multiple ways. Hybrid shopping basket/vehicles may also carry transceivers and radio-frequency tags readers or transponders to better control inventory, and may be adapted to broadcast information on position and contents and to display advertising panels, directories, maps, LEDs or audio devices.

The foregoing and other objects, features, aspects and advantages of the present invention will become apparent from the accompanying detailed drawings and disclosure.

### BRIEF DESCRIPTION OF THE DRAWINGS

FIG. 1 demonstrates conceptually how a hybrid shopping basket/vehicle, or “shopping aid”, is used in action. The customer is typically the one who deploys the legs when desired; it may be a shopkeeper or employee who undeploys them. The devices embodied here are illustrative of a family of hybrid shopping basket/vehicles and are not limited to any one form alone.

FIG. 2 is a conceptual schematic showing a side view of an assembled hybrid shopping basket/vehicle in action. The drawing demonstrates how an embodiment of a hybrid shopping basket/vehicle is cycled reversibly from a legs-up configuration to a legs-down configuration and back.

FIG. 3 is an exploded view of one mechanism for deploying and undeploying the legs and wheels of a hybrid shopping basket/vehicle. In this illustrated embodiment, the undercarriage is integral to the open basket and formed in a single mold during production, then machined to receive attaching parts and fasteners. A mechanical train is used to link the motion of the legs together.

FIG. 4 is an alternate embodiment showing a detachably attachable basket and separate undercarriage, but otherwise similar to FIG. 3. A variety of attaching means are obvious, but shown here are bolts or screws.

FIG. 5 shows an end-on elevation view of the mechanism illustrated in FIG. 4, with the legs in an undeployed configuration.

FIG. 6 shows a side elevation view of the mechanism illustrated in FIG. 4, with the legs in the undeployed configuration.

FIG. 7 shows a side elevation view of the mechanism illustrated in FIG. 4, with the legs in the deployed, legs-down configuration. The offset pivot struts function as locking and bracing struts on the fully deployed legs.

FIG. 8 is a flat plan view from the underside of the assembled mechanism illustrated in exploded view in FIG. 4, showing the legs in a deployed, legs-down configuration. The legs are not visible, standing beneath the casters in this view.

FIG. 9 is a flat plan view from the underside of the assembled mechanism illustrated in exploded view in FIG. 4, but showing the legs in a undeployed, legs-up configuration. Note the position of the casters on the legs.

FIG. 10 is an alternate embodiment. The detailed “works” shown here in plan view from the underside of the basket and undercarriage are distinct from that shown in FIG. 3 or 4. A gear box is used instead of a scissors tongs to link the motion of the legs, mechanical train, and control handle. FIG. 10 shows the legs in a “legs-down” position, fully deployed.

FIG. 11 represents the same works shown in FIG. 10, but the legs are in the “legs-up” position. Gear plates control the motion of the offset pivot struts.

FIG. 12 shows a hybrid shopping basket/vehicle, but the legs are compound, having pivoting “knees” and segments that fold back on themselves. This embodiment is also unique because it features a lower shelf. A simplified mechanical train is possible because the lower shelf has the effect of coordinating the motion of the legs. In one embodiment, springs in the knees are used to lock the legs against chocks in the fully extended configuration.

FIG. 13 develops the embodiment shown in FIG. 12. These embodiments demonstrate ways whereby a hybrid shopping basket/vehicle can be accomodated to taller individual users. In the upper view, a telescoping handle is shown. In the other of these embodiments, the height of the basket, again with compound legs, exceeds the length of the base. The basket itself is raised to a height about double the length of the base by means of nested compound legs. These legs still fold into a space no larger than the footprint of the basket, permitting nesting of the hybrid shopping basket/vehicles in a vertical stack. A lower shelf is employed to increase the useful area of the vehicle. Multiple shelves are possible by repeating this theme.

FIG. 14 is a rendering in perspective of an alternate embodiment having three legs in a scissors-leg configuration. While the vehicle shown here again has four wheels, embodiments with alternate number of wheels, for example three or even eight, are possible. Small casters are again shown, but larger wheels useful for rough surfaces are also possible. The release or trigger mechanism has also been modified for end access. The range of potential embodiments is not limited to the selected embodiments illustrated here.

### DETAILED DESCRIPTION OF SELECTED EMBODIMENTS

Words and phrases used here take their meaning as consistent with usage as would be apparent to one skilled in the relevant arts or by reference to a contemporaneous edition of Webster's unabridged English dictionary, unless another meaning is explicitly defined herein. When cited works are incorporated by reference, any meaning or definition of a word given in any incorporated reference that conflicts or embellishes the meaning as used here shall be considered idiosyncratic to said reference and not the meaning of the word as used in the present disclosure.

Automatic—a mechanical device that acts in a preset way without human effort or intervention after an operator triggers the action. The operator, by triggering a switch, clasp, lock, catch, button, lever, pin, or other release mechanism, sets in motion one or more “automated” movements of a machine.

Deploy—to open up by releasing or unfolding, to place in service, to cause the legs of an hybrid shopping basket/vehicle to extend and assume a “legs-down” configuration wherein the basket becomes freestanding. Deployment may be automatic, semi-automatic, or manual. The opposite of deployment is “undeployment”: verb form, “undeploy”, as in “the boxboy undeployed the hybrid shopping basket/vehicle and gave it to the next customer to carry”.

Disassemblable—that combination or assembly which can be disassembled into component parts; that which can be taken apart.

Generally—an expression of inexactitude, the condition of being more or less, approximately, or almost, where variations would be insignificant, obvious, or of equivalent utility, and further indicating the existence of obvious exceptions to a norm or rule.

Handle—that part of a basket or cart which is held, turned, lifted, pulled, gripped, or pushed by the hand of the user. Handles may be specially adapted for pulling (wherein they are often hinged), for pushing (wherein they are generally made fixed in orientation at an inclination toward the pusher), or for lifting and carrying, where the handle must support the basket regardless of how a load in the basket is distributed. Basket handles for carrying are most commonly appended perpendicularly from the level basket, or are hinged so as to become plumb when lifted. Pairs of pivoting handles separated at the base are grasped in one hand so that the handle struts form a triangular cross-section, stabilizing the position of the basket level to the floor. Double-handled shopping baskets are designed in common usage so that the two handles fold out flush against the end lip of the basket, out of the way, as is necessary for baskets that are nested in vertical stacks. Some handles are extensible, often with telescoping sections, and may have triggers or other controlling means embedded in the handle for convenient access. Handles may be specially adapted for dual use, such as by providing a detent when a handle is positioned at an angle or length preferable for pushing or pulling, but releasable so that the same handle can swing to an upright or plumb position, shortened if necessary, and be readily gripped for carrying. Handles operated for carrying in pairs may also be specially adapted for pushing when not used in carrying, and in those kind of embodiments, generally only one handle is used at a time for pushing. Some handles are adapted as straps for carrying over an arm or shoulder; in these embodiments, an alternate handle may be provided for pushing or pulling the shopping vehicle, if desired.

Hybrid shopping basket/vehicle—A combination of a lightweight shopping basket with wheeled carriage legs that can be retracted or deployed. These hybrid shopping basket/vehicles are termed “shopping aids”.

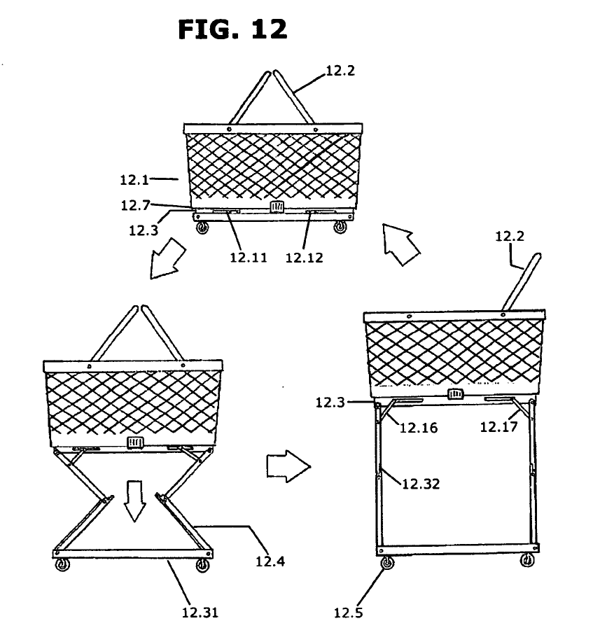

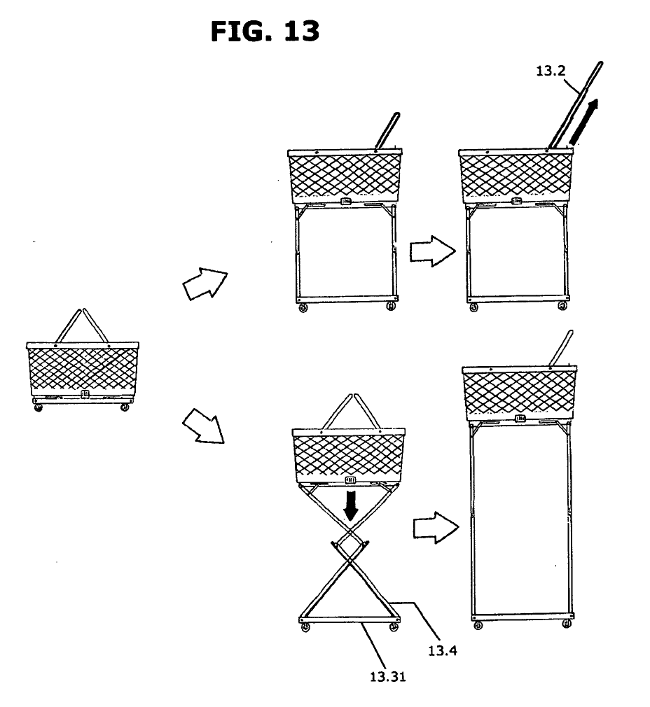

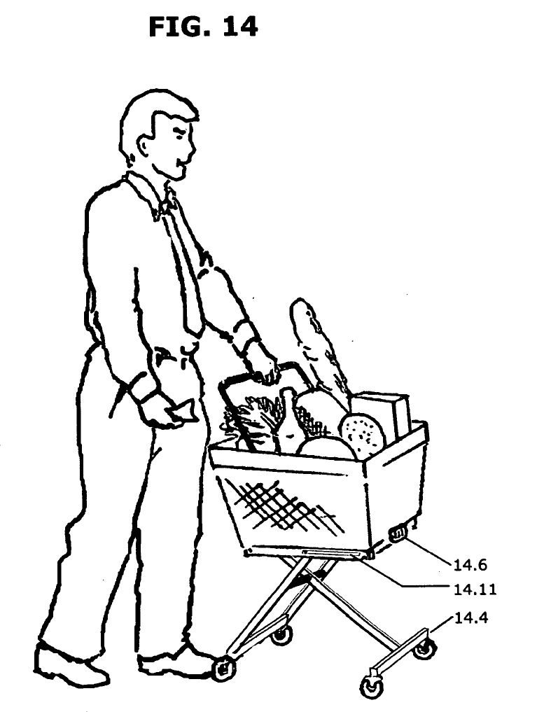

Leg—also “carriage leg” or legs, a rigid supporting member having a length substantially greater than its thickness, as in “standing on two legs”. In addition to bent, cambered and straight legs, styles of legs can be described by reference to the alphabet, there being “I”-legs, “L”-legs “S”-legs, “T”-legs, inverted “T”-legs (illustrated in FIG. 14), “U” legs, etc. Paired legs include members such as the “H” leg, which is joined by an intermediate crosspiece, and the “X”, or scissors leg (illustrated in FIG. 14), most commonly having a pivot at a a joint intermediate on the legs, as in a collapsable ironing board. There are also telescoping legs and compound legs, such as legs with “knees”. A multi-partite leg that folds back upon itself at knees is termed a compound leg. Compound legs with a single knee are illustrated in FIGS. 12 and 13. Any given leg may have attached wheels number-ing 0, 1, 2, 3, 4, 5 or 6, the wheels typically being in pairs or separated on a common axle, for example a “C” leg may have 2 wheels or 2 pairs of wheels mounted on the lower transverse member at each side. Centrally mounted wheels are also useful. By increasing the diameter of the wheels, more rough floors can be traver-sed. By the use of softer tread, traction may be in-creased, while quieting the vehicle. Legs with a positive camber may be more stable if needed. In some embodiments, the wheels are not mounted on the legs at all, but are instead affixed on an inferior aspect of the shopping vehicle, for example a lower, deployable shelf.

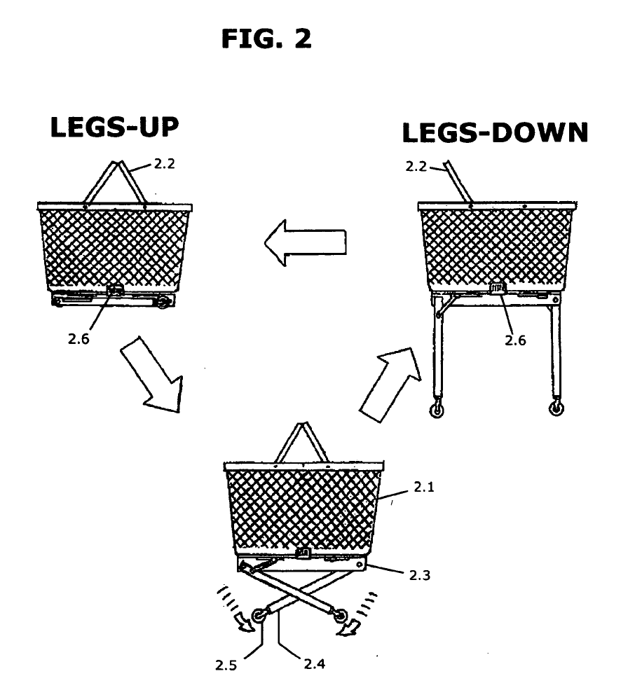

Leg configurations—of which there are two here, “legs-up” and “legs-down” as shown in FIG. 2, refer respectively to a configuration of the legs of a hybrid shopping basket/vehicle: a) legs-up—undeployed, generally parallel to and closely secured under the base of the basket, and b) legs-down—deployed, standing substantially erect, stably and elevatingly supporting the shopping basket at a convenient height, as in “freestanding on its two legs”. By definition, a hybrid shopping basket/vehicle deploys on its legs at a convenient height for the shopper to push or pull, steer the basket, and to reach the contents of the basket. In the examples shown here, a convenient height, with wheels contacting a gen-erally level and firm floor or slab, is defined as—the base of the basket is stably supported about knee to waist height of the typical customer, more preferentially between 12 to 45 inches (114.3 cm), most preferentially between 16 to 36 inches (40.64 to 91.44 cm) above the floor, these ranges being adjustable and depending on the median or average height of the customers using the baskets, which may vary from place to place or store to store, and also depending on the sort of merchandise being sold. In one embodiment, the height of the base of the shopping vehicle, when supported freestandingly on its legs on a generally level and firm floor or slab, is substantially equal to the length of the basket at its base. Embodiments whereby this height may be exceeded are provided here, however.

Level—or “levelly”, referring to a position or attitude on a plane apparently intersecting the horizon in all directions; further indicating a stable position, as opposed to “tipped” or angled.

Lightweight—an object or device for carrying, typically weighing less than 12 pounds (5.44 kg), more preferably less than 6 pounds (2.72 kg), and most preferably less than 3 pounds (1.36 kg), well suited for being carried.

Plurality—anything in numbers of two or more.

Rigid—generally stiff, substantially inflexible, and resistant to bending in all but the thinnest cross-sections. Rigid materials include some plastics such as acrylic polyesters, acrylonitrile butadiene styrene (ABS), polyvinylchloride, nylon, polypropylene, styrofoam, particularly reinforced plastics such as epoxy with carbon fiber and fiberglass with chopped glass or metal fibers, where stiffness is controlled by the amount and type of reinforcing fiber, and also heavy metal wire, angle iron and folded sheetmetal. A particularly useful group are thermoplastics which can be injection molded at high temperatures and pressures without decomposition. Details of injection molding processes for the production of shopping carts are disclosed in U.S. patent application 2001/0035618 to DeCost, and incorporated by reference into this application for the production of hybrid shopping basket/vehicles as if fully set forth herein. Wood is also a rigid material, as are some woven baskets.

Semi-rigid—retaining a formed shape, and having resistance to bending, but relatively bendable; bending but not likely to fail by snap or shatter; bending with or without elastic memory; more malleable and ductile than “rigid”, but not collapsible as in a heap, ie. not a bag, net or sack. Semi-rigid materials include many plastics such as silicon, rubber, cellulose, polyethylene, thin sections of polycarbonate, and some polyesters. An elastic modulus can be picked as the cutoff between rigid and semi-rigid, but the break is not a sharp one and the distinction is a matter of degree, thickness of the part, and depending on the application. Many semi-rigid plastics are also soft, an important property for certain handle coatings, bumpers, friction surfaces, and inflatable tires.

Spring—a form most commonly of spring steel, but also of certain plastics, having elastic structural memory so that when deformed returns to its original shape with a force that obeys Hook's Law. Types of springs include coil springs, helical springs, jaw or torsion springs (as in a common mousetrap), compression springs, and leaf springs.

Step for—an act in a method, having a purpose, a means or way of doing, and an implicit result.

Trundle—the motion of a basket or cart on small casters or wheels; used here as a verb, “to trundle”, to denote the very responsive way in which a basket or cart on small wheels moves across a smooth floor or slab by gentle pushing or pulling. When associated with the use of casters in some embodiments, a trundling motion of a hybrid shopping basket/vehicle may further indicate its ability to spin or turn in circles upon its centerpoint and to make turns without any radius of turning, a valuable property in narrow passages such as some shopping aisles.

Undercarriage—a frame or structure supporting a vehicle above its wheels. Carriage legs may attach to an undercarriage. Running gear may be a component of an undercarriage. An undercarriage, in embodiments described herein, may be manufactured as integral to the basket, as in one mold by an injection molding process.

Herein, where a means for a function is described, it should be understood that the scope of the invention is not limited to the mode or modes illustrated in the drawings alone, but also encompasses other means commonly known in the art at the time of filing and other means for performing the equivalent function that are described in this specification.

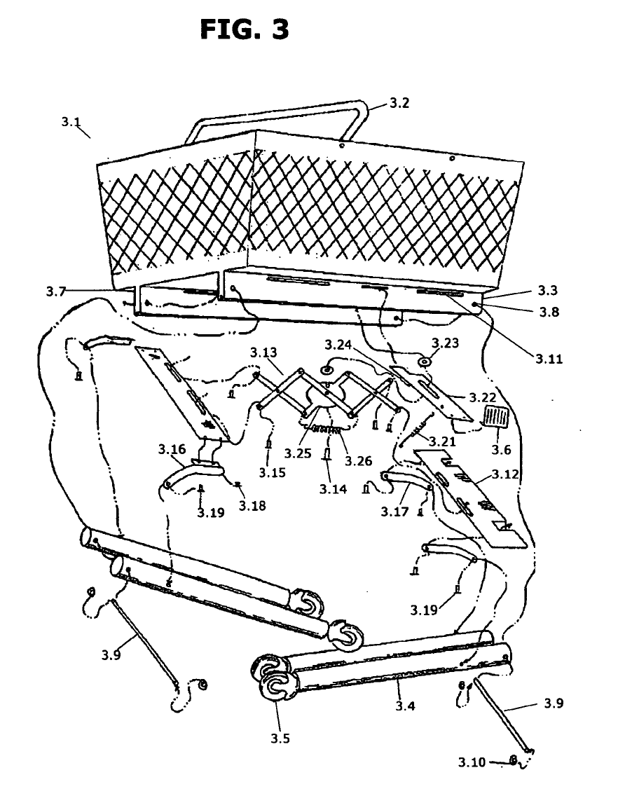

Means for releasably securing—encompasses lock-and-key mechanisms, trigger catch, cocking mechanisms, clasps, clips, levers, latches, pawls, rachets, detent pins and balls, both spring-loaded and mechanically operated, also velcro® and magnets, as may be used to hold the legs in a legs-up position when a hybrid shopping basket/vehicle is carried or nested. Mechanisms for securing the legs can also include a spring sufficiently stiff to hold the legs up. Or conversely, a spring can be used to assist in releasing and deploying the legs. Means for releasably securing are illustrated for example in FIGS. 3, 4, 8, 9, 10 and 11.

Means for linking—encompasses any mechanical train of levers, gears, cams, rods, pulleys, offset pivoting struts, cables, arms and sliding or rolling members, along with necessary hardware such as rivets, pivot pins, axles, bearings, bearing races, and fasteners, that directly and indirectly transfer the motion of one member to the motion of another. Means for linking are illustrated for example in FIGS. 3, 4, 8, 9, 10 and 11. Means for linking are used to transfer a mechanical signal from the control handle or arm to the legs. In FIGS. 12 and 13, a lower shelf links the motion of the legs together.

Means for triggering—encompasses the turning of a key, the pressing of a button, the pulling or pushing on a lever from side to side, up to down, or from in to out, the deformation of a gripping surface as in a snap release, the pulling of a trigger, latch, or handle by a digit, positive or negative pressure releasing a detent as of a clasp, lock, catch, cable, winch, pulley, clip or pin, whereby a signal to initiate a mechanical operation is given by an operator. Means for triggering are illustrated for example in FIGS. 3, 4, 8, 9, 10 and 11.

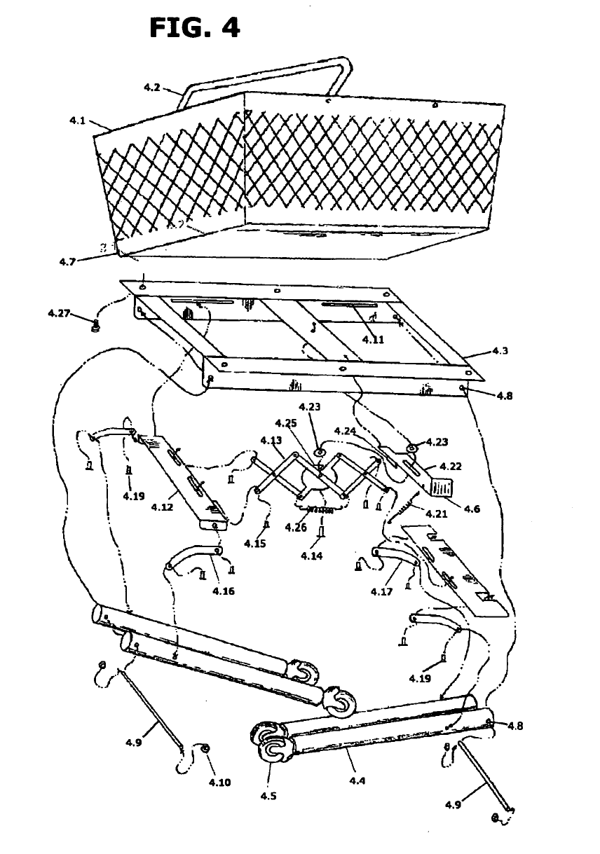

Means for detachably attaching—encompasses hardware used to attach a basket to a frame or undercarriage from which legs depend. These means include screws, bolts, nuts, ties, latching clamps, screwing clamps, spring clamps, straps, anchor pins, velcro® fasteners, cotter pins, snap fittings, ratcheting fittings, and the like commonly known in the art. One simple illustration of a means for detachably attaching a basket to a frame is shown in FIG. 4. The attachable basket may be a commercially available shopping basket, or one provided with its mated undercarriage or frame.

Means for braking—encompasses friction pads, friction levers, brake shoes, braking cable controls, mechanical linkages for braking, pneumatic brakes, wheel locks, and other generally well known means for dissipating the energy of motion as heat or preventing motion by locking a wheel or wheels in place. Brakes may be applied momentarily to slow motion, or fixed in place to lock a vehicle in place. Exemplary braking mechanisms are shown in U.S. Pat. No. 5,649,718 and U.S. Pat. No. 5,906,383, incorporated here by reference as if the relevant illustrations of braking means are reproduced herein.

Means for locking [legs deployed]—encompasses impinging surfaces such as chocks, locking or extensible struts, flying crosspieces with offset pivotable struts, keys, detent pins, spring-loaded balls, clamps, and their corresponding receiving surfaces such as stubs, keyholes, and detent receivers; also magnetic attachments. Other illustrated means for locking are shown for example in FIGS. 3, 9, and 11. Legs with a positive camber are potentially self-locking in the legs-down position. Means for locking in the legs-down configuration are distinguished from means for detachably attaching, which applies to the legs-up position.

Hybrid shopping basket/vehicles and their methods of use have multiple embodiments and variants, and more than one presently preferred embodiment are illustrated in the drawings. These are discussed in greater detail hereafter. It should be understood that the disclosures here are to be considered exemplifications of the invention in its presently preferred and most presently preferred embodiment, and are not intended to limit the claimed invention or any improvements upon the claimed invention to the specific embodiments illustrated here.

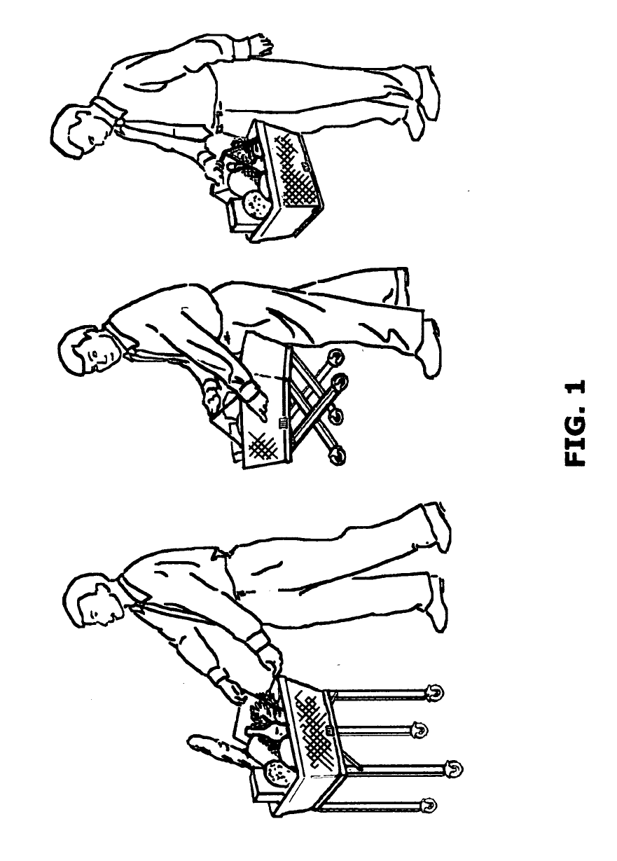

With reference to the figures, FIG. 1 shows a sketch of a shopper carrying what appears to be a full shopping basket. The shopper stops, pulls a releasing handle, and carriage legs with casters or wheels deploy from the beneath the basket, whereby the shopper is able to roll the shopping basket comfortably, steering by grasping the basket's handle or other means. The hybrid shopping basket/vehicle is a combination, modified shopping basket having vehicular elements including legs and wheels. Also embodied are means for releasably securing the legs and wheels against the base of the shopping basket when not in use, and means for triggering release and deployment of the legs when the shopper chooses. When released from a securely held configuration under the basket, the legs pivot from the legs-up to the legs-down position. This pivot may be the action of gravity on the free leg ends, and may also employ braking devices such as friction pads, countersprings, or pneumatic brakes to slow the descending motion out of safety considerations. Spring means may also be used mechanically assist the hybrid shopping basket/vehicle to “stand up”. Gravity, spring force or mechanical means are used to ensure that the legs remain locked in the fully deployed, standing position while weight bearing and moving.

The cartoon illustrates an embodiment of the invention as a specially adapted method of shopping. While carrying the hybrid shopping basket/vehicle, the shopper can trigger deployment of the legs and wheels, so that the basket can be freestandingly rested on the wheels. When the legs and wheels are deployed, the shopper can roll, trundle or wheel the shopping basket in the manner of a wheeled vehicle from place to place in any direction.

Note that in this embodiment the illustrated shopper is able to deploy the legs with his free hand while carrying the basket with his other hand by actuating a trigger positioned on the side of the basket. Alternatively, a shopper can manually extend the legs with one hand while holding the basket with the other. After extending the legs, the shopper is able to continue shopping. This shopper has added a baguette to the basket after extending the legs.

A body member, most preferably a hand or digit, is used to trigger deployment of the legs. When a hybrid shopping basket/vehicle is freely standing on its legs, three or more wheels are contacting the floor. One pair of casters in combination with a pair of fixed wheels at one,end, or a set of casters having an offset, generally vertical axle for steering (ie. a double-axle), are more sensitive in responding to changes in direction than four fixed wheels. Hybrid shopping basket/vehicles with casters may be trundled, a motion common during shopping. A hybrid shopping basket/vehicle is typically pushed or pulled by the basket rim or by a handle, but may be left at rest, freestanding and levelly supported on the floor.

In the remaining figures, references are made by number to parts. These numbers indicate the drawing number first, and the part number second, after the decimal place, to indicate that the same or an equivalent part appears in more than one drawing. Parts having the number, for example, X.1 are related in function, no matter the value of X.

FIG. 2 is a conceptual schematic showing a side view of an assembled hybrid shopping basket/vehicle in action. Views labelled “Legs-up” and “Legs-down” are basic to an understanding of the invention, and indicate the position of the legs when “undeployed” and when “deployed” respectively. The illustrated shopping basket (2.1) is shown with an undercarriage (2.3) and legs (2.4) fitted with casters (2.5). The drawing demonstrates conceptually how an embodiment of a hybrid shopping basket/vehicle is cycled reversibly from a legs-up configuration to legs-down configuration and back (arrows). Also shown is a control handle (2.6) for operating the release mechanism and a basket handle (2.2) for carrying and pushing the hybrid shopping basket/vehicle. The basket handle(s) is shown in two positions, one for carrying the basket (legs-up) and one for pushing the basket (legs-down).

In the legs-up position, the hybrid shopping basket/vehicle is shown as the customer typically might find it, with legs securely but releasably tucked up against the undercarriage. In the next panel (arrow), the legs are shown in an intermediate position in the act being deployed. And in the final panel (arrow), the legs are fully deployed and the basket is elevated, level, and fully supported by legs (2.4) on casters (2.5).

FIG. 3 describes the inner workings of the device of FIG. 2 in exploded view, permitting a working hybrid shopping basket/vehicle to be constructed. From the top left, shown are a shopping basket (3.1) with integral molded quadrilateral frame and longitudinal beams (3.3) forming an undercarriage in the base (3.7) of the basket. At each end of the beams, pivot holes (3.8) are drilled accepting a front and back carriage axle (3.9) on which are mounted (with fasteners, 3.10) legs (3.4), shown here as tubular members, pre-assembled with casters (3.5) at their lowermost inferior aspect. In both beams, slotted tracks (3.11) are drawn, to be cut, molded or milled through the beams longitudinally and symmetrically to the right and left of center. The assembly of flying crossplates (3.12) captive and movable within the slotted tracks is shown for both ends of the cart. The crossplates function to link the motion of a compound scissors tongs (3.13) mounted on central pivot head (3.14) with the longitudinal, reciprocal motion of the flying crossplates from end to end in the slotted tracks (3.11). Pivot pins (3.15) slidingly link the end arms of the compound scissors tongs with the flying crossplates, in slots in the flying crossplates to allow play for the lateral expansion and retaction of the scissors tongs during motion. On each end of the crossplates, an offset pivot strut, of which there are two, one inside and one outside of the nested legs (3.16; 3.17) affixed with rivets (3.18) or pivot pins (3.19) [and pivot stubs (3.20) when a slotted offset pivot strut is used], links the motion of the flying crossplates with the pivoting of the attached leg on the axles. A spring-mounted (3.21) sliding control arm (3.22) is captured on the central pivot head (3.14) between two spacer or lug washers (3.23) under the base. The outside end of the sliding control arm is formed in the fashion of a control handle (3.6), to be pushed by the shopper to release and deploy the legs. The sliding control arm is folded, milled or cast so as to form a detent pin (3.24) shown here as a folded flap of material extending inferiorly from the sliding control arm. This detent pin has one mated detent pin receiver (shown here as a slot in the disk) on the center arm (3.25) of the compound scissors tongs (3.13). Note that the center arm rotates on the central pivot head (3.14). In this exploded view, the device is shown in a partial legs-down configuration. As the legs are extended manually, or by the weight and momentum of the falling legs, the center arm of the scissors tongs rotates counterclockwise (viewed from below) until the slot on the center arm disk is engaged by the detent pin (3.24) on the spring-loaded (3.21) sliding control arm (3.22). A main spring (3.26) clasping two arms of the compound scissors tongs opposes the fall of the legs, slowing their descent. When the legs are no longer needed, the control handle (3.6) is pushed again to disengage the detent pin (3.24) from its locking position, permitting the legs to be folded up against the undercarriage.

In FIG. 4, a second embodiment is shown. This embodiment differs in that a detachably attachable undercarriage (4.3) is shown which is not integral to the shopping basket (4.1). The two parts of the assembly kit are detachably attachable by means of screws or bolts (4.27). One of two rigid handles (4.2) are shown. Note that parts numbering in this figure correspond after the decimal place to parts numbered in FIG. 3 except where new hardware is introduced.

While the mechanism of action, the mechanical train linking the motion of the legs and the center arm (4.25) of the compound scissors tongs (4.13), is similar to that described in detail above for FIG. 3, there are differences. In this embodiment, the center arm of the scissors tongs has a detent receiver slot (not numbered) for both the legs-up and legs-down configuration, as shown in more detail in FIG. 9. One slot is concealed under an overlapping second arm of the scissors tongs. By providing two detent sites for the sliding control arm's detent pin (4.24), the legs can be locked when in both the legs-up and legs-down position, permitting the use of a less stiff spring (4.26). The legs are physically “cocked” in the legs-up position and fall of their own weight when the detent pin is released from its receiver slot by pushing in on the control handle (4.6). During the fall of the legs, the center arm disk rotates while the detent pin follows on its circumference. At the instant that the legs become fully extended, the detent pin finds the second slot on the control arm and drops into it, because the control arm is spring-loaded (4.21), thus locking the legs in the legs-down standing position.

In operation, a shopper deploys the legs on a hybrid shopping basket/vehicle by pulling the control handle, causing the detent pin to be withdrawn from the detent pin receiver (here a slot in the center arm of the scissors tongs), whereupon all legs pivotally lower in unison, locking in the legs-down configuration as said flying crossplates slide laterally in their tracks, the scissors tongs extend, and the center arm of the scissors tongs rotates around the center pivot head, the entire operation being reversible.

The legs then lock in place as the spring-loaded control arm (4.22) and detent pin (4.24) finds its second mated detent receiver slot (not shown, see FIG. 9) corresponding to the radial position of the center arm of the scissors tongs with legs down. The position of the main spring may be crosslateral on the compound scissors tongs, accelerating the pivot motion of the legs into a locking position or parallel, or clasping from tip to tip of the scissors tongs jaws, serving as a counterspring to slow the descent of the legs after release. A stiffer spring may be used to hold the legs in the legs-up position until manually deployed, if desired.

In this assembly, rivets are not used to attach the offset pivot struts (4.16 and 4.17). Pivot pins are used for both the leg (4.4) and flying crossplate (4.12) connections. The use of folded sheet metal to form an undercarriage slightly changes the way in which the center pivot head (4.14) is mounted, as compared to FIG. 3.

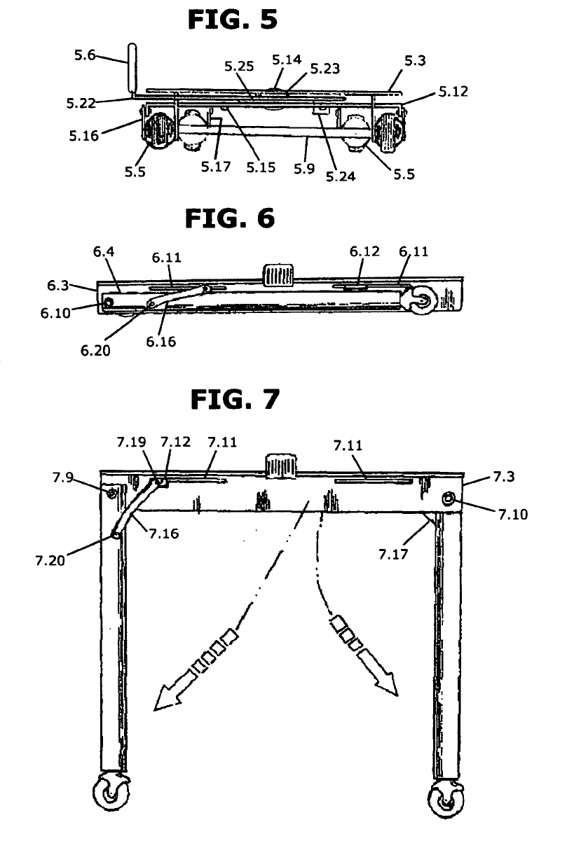

For clarity, FIGS. 5 through 9 detail operating assembly views of the device shown in FIG. 4.

FIG. 5 is an end view of the legs (5.4) and casters (5.5) folded up against an undercarriage (5.3), (basket not shown). Visible as if in cross-section are the control arm (5.22), detent pin (5.24) and control handle (5.6). Secured by the center pivot head (5.14) to the undercarriage, the center arm (5.23) of the scissors tongs is visible between spacer washers (5.23), sliding control arm, and flying crossplates (5.12). Also shown are the pivot pins of the flying crossplates and the outside (5.16) and inside (5.17) offset pivot struts. Springs are not shown in this view.

FIG. 6 is a side view of the legs and casters as assembled per FIG. 4, again folded up. The slots for travel of the flying crossplates along the undercarriage beam (6.3) are clearly visible. Only the outside offset pivot strut (left, 6.16) and pivot stub (6.20) is visible however, because the inside strut attaches to its flying crossplate (right, 6.12) inside the undercarriage beam. The fitting (6.10) securing the here left axle (7.9) is visible extending through the left leg (6.4).

FIG. 7 is a companion side view to FIG. 6, showing the leg motion after deployment. The legs are now in the fully deployed, legs-down position (arrows). Visible are the left and right axles (7.9), the inside and outside offset pivot struts (7.16; 7.17), the slotted tracks (7.11) and captive flying crossplates (7.12), attaching pivot pin (7.19) and leg-mounted pivot stub (7.20). Because the right leg nests inside the left leg and behind the undercarriage support when folded, the right offset driving arm (7.17) is not fully visible in this view.

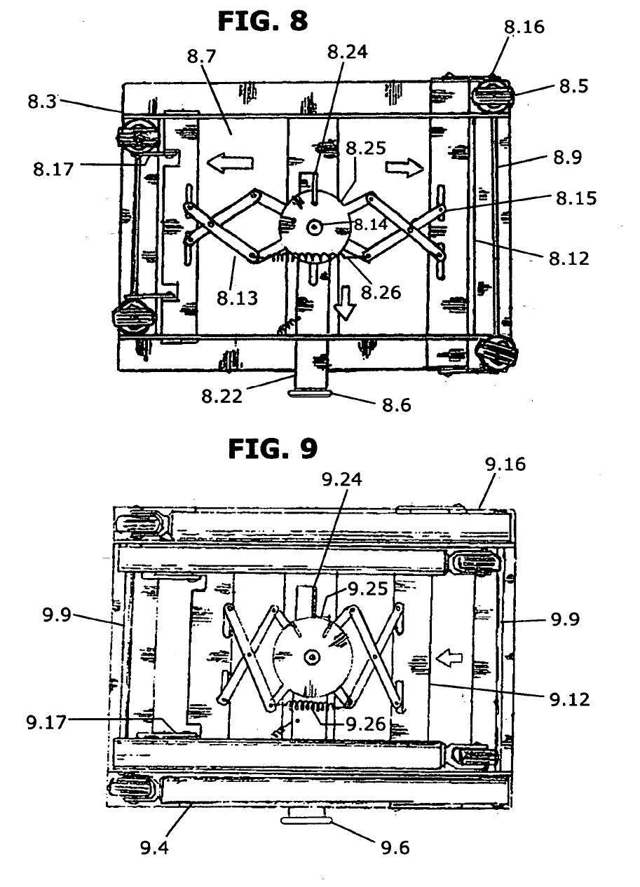

FIG. 8 illustrates an underside view of the mechanical linking train of FIG. 4 in the legs-down configuration. The drawing shows that the center arm (8.25) of the scissors tongs has rotated about a quarter turn, and the detent pin (8.24) has found its mated receiver (here a slot) marking the position of the center arm in the legs-down configuration, effectively locking the legs in place because pivoting of the legs is mechanically linked to rotation of the center arm on the central pivot head (8.14). The compound scissors tongs (8.13) are fully extended in the legs-down configuration and the flying crossplates (8.12) have reached the most lateral stops of their respective tracks, as further indicated by the position of the scissors tongs sliding pivot pins (8.15) in their slots in the flying crossplates. Note the vertical position of the legs behind the casters (8.4).

Also shown are the underside of the basket (8.7), the undercarriage beams (8.3), axles (8.9), inside and outside offset pivot struts (8.16; 8.17), central pivot head (8.14) and counterspring (8.26), control arm (8.22) and control handle (8.6).

FIG. 9 illustrates the mechanism in the legs-up configuration after release of the detent pin (9.24) from its detent receiver slot on the center arm disk (9.25) of the scissors tongs. The center arm disk is rotating counter-clockwise in this view from below. Note that the detent pin (9.24) has disengaged between FIGS. 8 and 9, and the slots in the center arm disk have rotated. The detent pin is following the circumference of the center arm disk as it rotates. About a quarter turn of the center arm disk is required as the legs move into the releasably secured, legs-up configuration. The rotation is counter-clockwise from below to secure the legs up; clockwise from below to deploy the legs-down. As the legs become completely folded, the spring-loaded detent pin will find its mated receiver slot, which is moving closer as the center disk rotates counter-clockwise. The scissors tongs are contracting and the flying crossplates (9.12) are moving toward the center of the device (arrow). This motion is aided by spring (9.26), which can be stiff or weak.

Also shown are the inside (9.17) and outside (9.16) offset pivot struts attached to the legs (9.4), both axles (9.9), and the control handle (9.6).

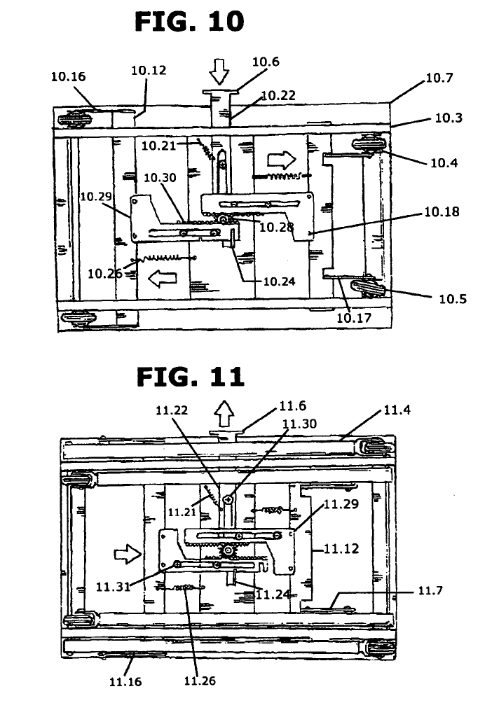

In FIG. 10, another alternate release and deployment mechanism is developed in working drawings. The plan view shows a gear box mounted on the base of the basket (10.7), with integral undercarriage beams (10.3) as shown in FIG. 3, but with pinion gear (10.28), gear rack and gear arms (10.29; 10.30), flying crossplates (10.12), bolted or riveted (10.18) to the gear plate, outside and inside offset pivoting arms (10.16; 10.17), and casters (10.5) mounted on square legs (10.4). Also shown is the control handle in a position (10.6) with legs down and locked by detent pin (10.24). Pushing on the control handle (arrow) releases of the legs from their fully upright, locked position (shown here), allowing them to be brought up against the undercarriage (as shown in FIG. 11).

Alternatively, pinion and spur gears may also be used to effect the motion of driving rods (not shown), which may be mounted near the circumference of the spur gear or gear disks. A pivoting handlebar-shaped cross-rod may be used in place of the crossplates and offset pivoting arms shown in the figure, the handles of the cross-rod inserting through the legs at an intermediate pivot point on the legs, and the bar at the neck of the handlebar linking the rotation of the spur gear to the action of the legs by means of the driving arms mounted on the handlebar. Gears and pivot arms may be machined or molded from plastic or metal, and metal wire of the required gauge may be used to reinforce parts where plastic alone lacks sufficient strength. Metal wire or rod for example can be used to form crossrods and offset pivoting arms, with or without plastic. Gear plates may be machined or molded, such as from Nylon 66, ABS, fiber reinforced polyester, or lightweight aluminum.

FIG. 11 describes the action of the gear box as the legs are brought up into the “cocked” position against the undercarriage. The control arm (11.22), spring-loaded (11.21), falls into a second detent slot on the gear plate (11.29). When this occurs, the control handle moves out (arrow) into the “cocked” position. When the handle is pushed in, ie. release of the legs is “triggered”, the detent is released from its detent receiver slot, the legs fall, an action opposed and slowed by countersprings (11.26), and the detent pin again locks in a second, deeper slot in the gear plate at the most fully extended position, legs-down, thus holding the legs secure in their deployed configuration. Flying crossplates (11.12) communicate the rotation of the pinion gear to the legs by means of offset pivot struts (11.16; 11.17).

FIG. 12 is a schematic describing the operation of a hybrid shopping basket/vehicle with compound legs. The shopping basket (12.1) is fitted with two handles (12.2) as shown here, and with an undercarriage (12.3) molded or attached to the basket base (12.7). The motion of the legs (12.4), with compound segments and knees, is optionally controlled by inside and outside offset pivot struts (12.16; 12.17) mounted to flying crossplates (12.12) captive in slotted tracks (12.11) in the undercarriage beams (12.3). Casters (12.5) are attached to a lower shelf (12.31), which is in turn attached to the lower aspect of the compound legs, stabilizing and coordinating their motion. Locking knees (12.32) with chocks and spring-loaded detent pins (not shown) provide rigidity in the legs-down configuration. The legs can also have positive forward and lateral camber to assist stability. A control handle such as described in previous figures is used to trigger the deployment of the legs.

FIG. 13 is a conceptual view demonstrating two ways whereby a hybrid shopping basket/vehicle can be accommodated to taller individual users. In the upper panel, a telescoping handle (13.2) is shown. In the lower panel, the compound legs (13.4) are lengthened, permitting the basket to be elevated as much as twice the length of the base. These legs nonetheless fold easily and are nested beneath an undercarriage, where they can be deployed when triggered. Also shown is a lower shelf (13.31) for transport of heavy or bulky items, or as needed.

FIG. 14 is a conceptual view of a 3-legged hybrid shopping basket/vehicle. Note also that the control release mechanism has been modified. The front scissors-leg (14.4) pivots at an intermediate crossbeam with the rear legs. Elements in the design of vehicles of this type can be extracted from Marcouiller (U.S. Pat. No. 2,531,856) and Dirkin (U.S. Pat. No. 1,081,221), which are incorporated by reference here as if reproduced in full. The trigger and control handle (14.6) mechanism is also modified, shown here in a front position on the shopping basket.

### EXAMPLE 1

A 1:1 scale model of the triggering release mechanism and mechanical train of FIG. 4 was built. The compound scissors tongs and center arm disk were cut from acrylic sheet with a band saw. The detent receiver and detent pin are dimensioned in FIGS. 3 and 4 from the model. Using the custom-built scissors tongs, the flying crossplates and their slots in the longitudinal beams were then sized and designed. The mechanism was demonstrated to operate essentially as shown in FIGS. 5 through 8. A bill of materials was drawn up and commercially available parts were priced and specified where feasible. Estimates for manufacturing costs were obtained.

Based on the model, the weight of a fully assembled hybrid shopping basket/vehicle of the embodiment of FIG. 4 was estimated to be 24 to 36 ounces (0.68 to 1.02 kg), depending on materials and estimated product time to repair or replacement, accounting for spring weakening and other factors in wear and tear. This compares to shopping baskets in commercial use which typically weigh 17 to 20 ounces (0.48 to 0.57 kg). A substantial component of the weight is in the rigid handle and basket rim, which may bear loads approaching 150 pounds (68.04 kg) failsafe. Rehrig has described ways to reinforce the rim (U.S. Pat. Nos. 4,865,338 and 4,946,059) of an injection-molded basket and lighter alternative handles, such as straps, are in use, particularly for example in Europe. In contrast, shopping carts in commercial use often weigh between 20 and 75 pounds (9.07 and 34.02 kg), impractical for lightweight carrying.

1. A hybrid shopping basket/wheeled vehicle comprising:
a) a shopping basket, said shopping basket further being generally lightweight for carrying, of a material selected from rigid or semi-rigid, and having walls not foldable and not disassemblable, rim, and base generally quadrilateral in shape, said base having ends, sides, center and corners;
b) four legs, said legs pivoting between a legs-up configuration wherein said legs are triggerably cocked and secured generally parallel to said base when undeployed, and a legs-down configuration wherein said legs stand upright, elevatingly supporting said shopping basket;
c) an undercarriage, integrally formed in said base, to which said legs are pivotally attached at said corners, further comprising two beams of generally rectangular cross-section, said beams spanning substantially from end to end of and generally parallel to the sides of said base, but inset from said sides by generally the cross-sectional thickness of one leg, each beam further having two slotted tracks extending symmetrically to the right and left of center for an intermediate length along said beams;
d) a means for releasably securing said four legs in the legs-up configuration, said means for releasably securing consisting of a mechanical linkage formed of scissors tongs center mounted under said base, a sliding detent pin, a mated detent pin receiver on said scissors tongs, sliding flying crossplates captive in said slotted tracks and attached at either end by pins to said scissors tongs, offset pivot struts pivotingly attached to said flying crossplates at their lateral aspect and to said legs at a pivot positioned at a radius intermediate along the length of each leg from its pivot axis;
e) a means for triggering release and deployment of said four legs from said legs-up configuration to said legs-down configuration, said means for triggering consisting of said mechanical linkage and a sliding control handle arm and control handle to operate said sliding detent pin;
f) when freestanding with said legs deployed, inferiorly attached wheels for rolling said shopping basket as a wheeled vehicle from place to place.

2. A hybrid shopping basket/vehicle of claim 1 further comprising a lower shelf, said lower shelf being attached at a lower aspect of said four legs, said four legs being compound legs, and said inferiorly attached wheels being appended to said lower shelf.

3. A hybrid shopping basket/vehicle of claim 1 further comprising at least one basket handle attached at the rim of said shopping basket.

4. A hybrid shopping basket/vehicle of claim 1, wherein said shopping basket is injection molded from a plastic.

5. A hybrid shopping basket/vehicle of claim 1 weighing less than 12 pounds (5.44 kg), more preferably less than 6 pounds (2.72 kg), and most preferably less than 3 pounds (1.36 kg).

6. A hybrid shopping basket/vehicle of claim 1 wherein said shopping basket/vehicle, freestanding on legs deployed and wheels contacting a generally level and firm underlying surface, is stably supported so that said base of said shopping basket is stably elevated and generally level at a height equal to or greater than the length of said base.

7. A specially adapted method for shopping comprising:
a) At times when carrying a hybrid shopping basket/vehicle of claim 1, a step for triggering deployment of said legs and inferiorly attached wheels, whereupon said shopping basket may be freestandingly rested on said legs and inferiorly attached wheels;
b) At times when said shopping basket is freestandingly rested on said legs and inferiorly attached wheels, a step for rolling said shopping basket as a wheeled vehicle from place to place.

8. A method of claim 7 further comprising returning said hybrid shopping basket/vehicle when not in use to a location at which a next shopper will pick up said hybrid shopping basket/vehicle; said legs having been brought up around said undercarriage, triggerably cocked and secured in a legs-up configuration in preparation for use by said next shopper.

9. A method of claim 8 further comprising a step for nesting unused hybrid shopping basket/vehicles in a vertical stack.

10. A method of claim 7 wherein said hybrid shopping basket/vehicle is wheeled from place to place while freestandingly rested and stably elevated at a generally level and convenient height.

11. A hybrid shopping basket/vehicle comprising:
a) a shopping basket, said shopping basket further being generally lightweight for carrying, of a material selected from rigid or semi-rigid, and having rim, base, and walls not foldable or disassemblable;
b) a plurality of legs attached at pivots to said shopping basket, further pivoting between a legs-up configuration wherein said plurality of legs are triggerably cocked and secured generally parallel to said base when undeployed, and a legs-down configuration wherein said plurality of legs stand upright and lock when deployed;
c) a means for releasably securing said plurality of legs generally apposed to the base of said shopping basket in a legs-up configuration;
d) a means for triggering release and deployment of said plurality of legs from said legs-up configuration to said legs-down configuration;
e) when freestanding in said legs-down configuration, inferiorly attached wheels for wheeling said shopping basket as a wheeled vehicle from place to place.

12. A hybrid shopping basket/vehicle of claim 11 wherein said plurality of legs are compound legs.

13. A hybrid shopping basket/vehicle of claim 11 wherein said plurality of legs number an integer selected from two, three or four, and further where said plurality of legs are selected from straight leg, bent leg, “tee” leg, “ell” leg, “C” leg, “H” leg, “I” leg, “O” leg, “T” leg, inverted “T” leg, “Z” leg, compound legs, paired legs, or scissors legs, where compound legs describes a leg comprising any pivoted leg submembers that fold back on each other, where paired legs describes two or more legs crosslinked by at least one crosspiece disposed along their lengths, and scissors legs describes any two legs joined by a pivot intermediate upon their lengths.

14. A hybrid shopping basket/vehicle of claim 13 wherein said legs are triggeringly deployed by use of a body member selected from hand, finger, thumb, arm, knee, or foot.

15. A hybrid shopping basket/vehicle of claim 13 wherein pivoting of said legs in at least one direction selected from legs-up to legs-down or legs-down to legs-up is assisted by gravity.

16. A hybrid shopping basket/vehicle of claim 13 wherein said legs lock in the legs-down position by spring action.

17. A hybrid shopping basket/vehicle of claim 11 wherein said plurality of legs, releasably secured in the legs-up configuration, are triggeringly deployed from said legs-up configuration to said legs-down configuration while carrying said shopping basket.

18. A hybrid shopping basket/vehicle of claim 11 weighing less than 12 pounds (5.44 kg), more preferably less than 6 pounds (2.72 kg), and most preferably less than 3 pounds (1.36 kg).

19. A hybrid shopping basket/vehicle of claim 11 wherein said hybrid shopping basket/vehicle, freestanding on legs deployed and wheels contacting a generally level and firm underlying surface, is stably supported so that said base of said shopping basket is stably elevated and generally level at a height equal to or greater than the length of said open basket.

20. A hybrid shopping basket/vehicle of claim 11, further comprising a means for braking that acts on at least one said wheel.

21. A hybrid shopping basket/vehicle claim 11 wherein said shopping basket is injection molded of a plastic.

22. A hybrid shopping basket/vehicle of claim 21, wherein said shopping basket is injection molded with an integral undercarriage.

23. A hybrid shopping basket/vehicle of claim 22, wherein a handle is integrally molded with said shopping basket.

24. A hybrid shopping basket/vehicle of claim 11, further comprising an undercarriage to which said legs are attached.

25. A hybrid shopping basket/vehicle of claim 24, further comprising a means for detachably attaching said undercarriage from said shopping basket.

26. A hybrid shopping basket/vehicle of claim 25, wherein said shopping basket is provided separately.

27. A hybrid shopping basket/vehicle of claim 11 further comprising an informational data transceiver.

28. A hybrid shopping basket/vehicle of claim 11 further comprising a radio frequency tag reader.

29. A hybrid shopping basket/vehicle as recited in claim 12, further comprising a lower shelf, said lower shelf being attached at a lower aspect of said compound legs.

30. A business method comprising a business model further comprising keeping spreadsheet records of inventory and sales performance, and at least one step selected from the list consisting of:
a) providing a customer with a hybrid shopping basket/vehicle of claim 11;
b) providing to a merchant by sale or lease a hybrid shopping basket/vehicle of claim 11;
c) providing to a customer a kit for assembly of a hybrid shopping basket/vehicle of claim 11; and,
d) providing to a customer a part for repair of a hybrid shopping basket/vehicle of claim 11.

31. A hybrid shopping basket/vehicle comprising:
a) a shopping basket, said shopping basket further being generally lightweight for carrying, of a material selected from rigid or semi-rigid, and having walls not foldable and not disassemblable, with base generally quadrilateral in shape, said base having ends, sides, and corners;
b) four compound legs attached to said base generally at the corners, said legs pivoting between a legs-up configuration and a legs-down configuration;
c) a lower shelf, said lower shelf being attached at a lower aspect of said compound legs;
d) a means for releasably securing said lower shelf to the base of said shopping basket, thereby securing said compound legs in said legs-up configuration;
e) wheels attached inferiorly to said lower shelf for wheeling said shopping basket as a wheeled vehicle from place to place.

32. A specially adapted method for shopping comprising use of a hybrid shopping basket/vehicle of claim 31.

33. A specially adapted method for shopping of claim 32 comprising:
a) At times when carrying a hybrid shopping basket/vehicle, a step for triggering deployment of said compound legs and wheels, whereupon said shopping basket may be freestandingly rested on said legs and wheels;
b) At times when said shopping basket is freestandingly rested on said legs and inferiorly attached wheels, a step for rolling said shopping basket as a wheeled vehicle from place to place.

34. A method for shopping as recited in claim 33, further comprising a step for placing goods on said lower shelf.

35. An article of manufacture comprising a hybrid shopping basket/vehicle of claim 31.

36. A business model comprising keeping spreadsheet records of inventory and sales performance, and having at least one step selected from the list consisting of:
a) providing a customer with a hybrid shopping basket/vehicle of claim 31;
b) providing to a merchant by sale or lease a hybrid shopping basket/vehicle of claim 31;
c) providing to a customer a kit for assembly of a hybrid shopping basket/vehicle of claim 31; and,
d) providing to a customer a part for repair of a hybrid shopping basket/vehicle of claim 31.
